(19) United States
(12) Patent Application Publication
(10) Pub. No.: US 2026/0079720 A1
(43) Pub. Date: Mar. 19, 2026

(54) DEPLOYMENT OF CONFIGURATION FILES GENERATED FROM SERVERLESS FUNCTIONS

(71) Applicant: RED HAT, INC., Raleigh, NC (US)

(72) Inventors: Leigh Griffin, Waterford (IE); Andrea Cosentino, Milan (IT)

(21) Appl. No.: 18/888,776

(22) Filed: Sep. 18, 2024

(51) Int. Cl. G06F 9/445

(52) U.S. Cl. CPC G06F 9/44505

(57) ABSTRACT

Some examples of the present disclosure relate to deploying configuration files generated from serverless functions. In one particular example, a system can receive a serverless function including a set of software elements. The system can determine resource requirements associated with executing the serverless function. The system can also determine a set of capabilities for a plurality of nodes. The system can generate a set of executable files corresponding to the set of software elements and the resource requirements. The system can assign a first executable file to a first configuration file based on the set of capabilities. The first configuration file is associated with a first node of the plurality of nodes. The system can execute the first configuration file having the first executable file using the first node.

### TECHNICAL FIELD

The present disclosure relates generally to software execution. More specifically, but not by way of limitation, this disclosure relates to deploying configuration files generated from serverless functions.

### BACKGROUND

Distributed computing systems (e.g., cloud computing systems, data grids, and computing clusters) have recently grown in popularity given their ability to improve flexibility, responsiveness, and speed over conventional computing systems. In some cases, the responsiveness and speed of distributed computing systems can be further improved by employing edge-computing solutions. Edge computing is a networking philosophy focused on bringing computing power and data storage as close to the source of the data as possible to reduce latency and bandwidth usage. The distributed computing systems can execute various types of software components to implement their functionality. Examples of such software components can include serverless functions. A serverless function can be an ephemeral, self-contained, discrete piece of code (e.g., set of logic or operations) configured to perform a particular task when executed and then become dormant when execution completes. One example of a serverless function can be a Lambda function in Amazon Web Services®. Serverless functions may be individually “owned” or developed by different developers and deployed independently of each other, which can provide improvements to scalability, robustness, isolation, and development time over conventional monolithic software-applications.

Given the complexity of some distributed computing systems, automation frameworks have been developed that help manage them more efficiently. These automation frameworks can help to automate the deployment, configuration, and management of various aspects of a distributed computing environment. One popular automation framework is Ansible by Red Hat®. Ansible is a software tool that can assist with deploying applications, updating workstations and servers, cloud provisioning, configuration management, and many other functions for systems administrators. When executed, small software programs called “modules” can configure managed nodes to conform to a target state. In Ansible, the modules provide a means to accomplish a desired automation task, but the way in which the modules are used is governed by a “playbook.” A playbook is a configuration file drafted in a human-readable language that provides instructions for what needs to be done to transform a managed node into a target state. Playbooks are typically written in a YAML Ain’t Markup Language (YAML) format, though other formats are possible.

### BRIEF DESCRIPTION OF THE DRAWINGS

FIG. 1 is a block diagram of an example of a system for deploying configuration files generated from serverless functions according to some examples of the present disclosure.

FIG. 2 is a block diagram of an example of a computing environment for deploying configuration files generated from serverless functions according to some examples of the present disclosure.

FIG. 3 is a flow chart of an example of a process for deploying configuration files generated from serverless functions according to some examples of the present disclosure.

### DETAILED DESCRIPTION

Serverless functions provide developers a way to generate software without considering where the software will run. Backend infrastructure can then select an appropriate device or node for executing the software based on resource availability and the needs of the software. But, understanding the needs of a serverless function may be difficult. In addition, in edge computing environments, there may be varying degrees of capabilities for the same type of devices. So, selecting the best device for executing a serverless function may be difficult, which may lead to devices being overloaded or underloaded. As a result, the overall performance of the system may be suboptimal.

Some examples of the present disclosure can overcome one or more of the abovementioned problems by providing a system that can deploy configuration files generated from serverless functions. In an example, the system can receive a serverless function including a set of software elements. The system can determine resource requirements (e.g., memory, bandwidth, compute, etc.) associated with executing the serverless function. The system can also determine a set of capabilities for a plurality of nodes. The system can generate a set of executable files (e.g., Ansible modules) corresponding to the set of software elements and the resource requirements. The system can assign a first executable file to a first configuration file (e.g., Ansible playbook) based on the set of capabilities. The first configuration file is associated with a first node of the plurality of nodes. The system can execute the first configuration file having the first executable file using the first node. The serverless function is thus decomposed and distributed across configuration files and nodes in a manner that improves performance of the system and individual nodes.

As a particular example, a computing environment can include two nodes. A first node can include fifty Megabytes (MB) of random access memory (RAM) and a second node can include thirty MB of RAM. The system receives a serverless function with a software element for creating a structured query language (SQL) database. The system then determines that the software element has a resource requirement of forty MB of RAM. The system generates an Ansible module for the software element and then assigns the Ansible module to an Ansible playbook associated with the first node, since the first node has the RAM capacity for executing the software element. Another executable file for another software element of the serverless function maybe assigned to the second node, if the other software element requires less RAM and the second node has sufficient amounts of other resources for the other software element. The first node executes the Ansible playbook with the executable file for creating the SQL database. As such, the serverless function is decomposed into Ansible modules based on the various software elements included in the serverless function. The Ansible modules are then distributed to Ansible playbooks for nodes with sufficient resources, leading to efficient resource utilization an improved execution of the serverless function.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

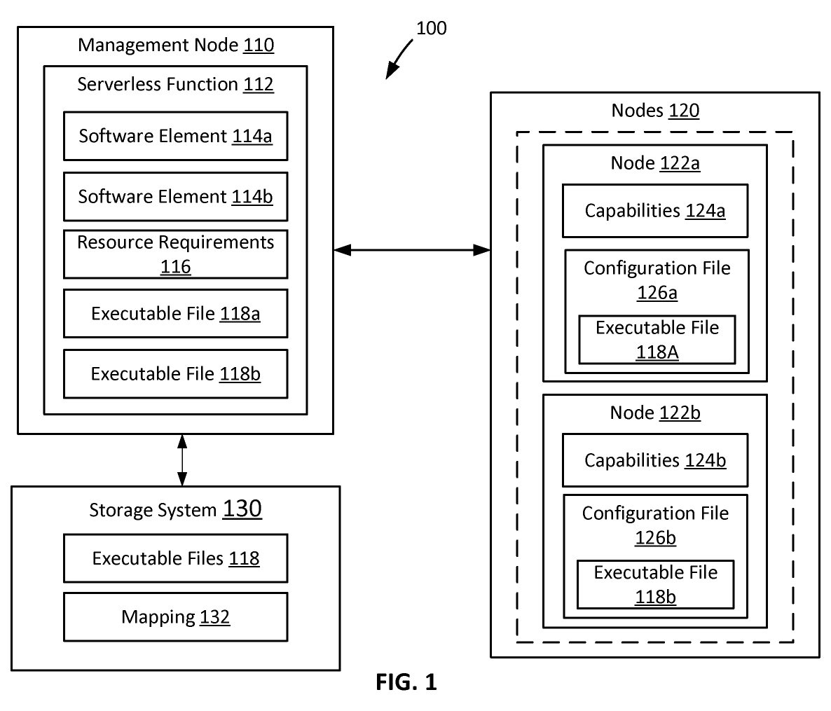

FIG. 1 is a block diagram of an example of a system 100 for deploying configuration files generated from serverless functions according to some examples of the present disclosure. In some examples, the system 100 may be a distributed computing environment such as an edge computing environment, a cloud computing environment, or a computing cluster. The system 100 can be formed from a management node 110, one or more nodes 120 (e.g., physical servers, virtual servers, Internet of Things (IoT) devices, etc.), and a storage system 130 that are in communication with one another via a network, such as a local area network (LAN), wide area network (WAN), the Internet, or any combination thereof.

The system 100 can include the management node 110 that can manage or otherwise communicate with nodes 120. Examples of the management node 110 or of the nodes 120 can include desktop computers, laptop computers, servers, mobile phones, tablets, etc. The nodes 120 may be edge devices such as Raspberry Pis, sensors, or other resource-constrained, IoT devices. As illustrated, the nodes 120 include node 122a and node 122b.

The management node 110 can receive a serverless function 112 that includes a set of software elements. For instance, the serverless function 112 is illustrated as including software elements 114a-114b. The software elements 114a-114b may be lines of code that, when executed, cause a particular task to be executed. In some instances, different software elements may consume or use various resources more or less than other software elements. For example, software element 114a may use more central processing unit (CPU) power than software element 114b, which may use more memory.

In some examples, the management node 110 can determine resource requirements 116 associated with executing the serverless function 112. For instance, the management node 110 can determine an amount of each resource (e.g., CPU, bandwidth, random access memory (RAM), disk input/output (I/O), etc.) that is needed to execute the serverless function 112. In addition, the management node 110 may determine an amount of each resource that is needed to execute each of the software elements 114a-114b.

The management node 110 can determine the resource requirements 116 by performing an execution of the serverless function 112 on a device and analyzing a usage of resources of the device for the execution. The device may be one of the nodes 120 or a different user device (e.g., a developer device on which the serverless function 112 is created). By executing the serverless function 112 on the device, an actual amount of resources that the serverless function 112 uses may be determined. As such, the resource requirements 116 for the serverless function 112 can be determined and an indication of the amount of the resource requirements 116 can be stored in association with the serverless function 112. So, when the serverless function 112 is to be executed, the management node 110 can determine the resource requirements 116 from the indication.

In some examples, the management node 110 may additionally or alternatively determine the resource requirements 116 by executing a benchmark test on the serverless function 112. The benchmark test may determine a performance of the serverless function 112, which can be compared against performance metrics for the serverless function 112. From the benchmark test, a usage of resources by the serverless function 112 can be determined, which can indicate the resource requirements 116 for the serverless function 112. So, an indication of the amount of the resource requirements 116 can be stored in association with the serverless function 112 based on the benchmark test. So, when the serverless function 112 is to be executed, the management node 110 can determine the resource requirements 116 from the indication.

The management node 110 can determine a set of capabilities of the nodes 120. The set of capabilities can correspond to capabilities 124a-124b, where capabilities 124a are capabilities of the node 122a and the capabilities 124b are capabilities of the node 121b. The set of capabilities may be a resource amount for the nodes 120. For instance, the set of capabilities may be a current amount of a resource available at the nodes 120. So, the set of capabilities can reflect a current load on the nodes 120. The management node 110 may periodically poll the nodes 120 to determine the capabilities 124a-124b. Alternatively, when a serverless function is to be executed, the management node 110 may poll the nodes 120 to determine the set of capabilities.

In some embodiments, the management node 110 can control deployment of instances of the serverless function 112 on the nodes 120 using a configuration management system such as Ansible by Red Hat®. For example, the management node 110 can use configuration files (e.g., Ansible playbooks) to automate deployment of the serverless function 112. The configuration files can include executable files (e.g., Ansible modules) that each include one or more tasks that the management node 110 can execute to deploy the serverless function 112 to the nodes 120.

In some examples, the management node 110 can generate a set of executable files corresponding to the software elements and the resource requirements 116. For instance, the set of executable files can include executable files 118a-118b. The executable file 118a can correspond to software element 114a and the executable file 118b can correspond to software element 114b. The executable file 118a may indicate the amount of resources needed to execute the software element 114a based on the resource requirements 116. Similarly, the executable file 118b may indicate the amount of resources needed to execute the software element 114b. As an example, if the software element 114a is CPU intensive, the executable file 118a can be an Ansible module that corresponds to the software element 114a and other software elements of the serverless function 112 that are also CPU intensive. If the software element 114b is RAM intensive, the executable file 118b can be an Ansible module that corresponds to the software element 114b and other software elements of the serverless function 112 that are also RAM intensive. In this way, executable files are generated that correspond to each compute resource.

The management node 110 can assign executable files to configuration files based on the capabilities of the nodes 120. Assigning the executable files involves the executable files being incorporated into the associated configuration files. Each node may be associated with a configuration file. For example, node 122a is illustrated as being associated with configuration file 126a and node 122b is illustrated as being associated with configuration file 126b. The configuration files 126a-126b can describe what is to be run on each of the nodes 122a-122b and the available resources for the nodes 122a-122b based on the capabilities 124a-124b. So, based on the resource requirements 116 associated with a given executable file, the executable file can be assigned to a particular configuration file. For example, if the executable file 118a is associated with the software element 114a and the resource requirements 116 indicate that the software element 114a uses 70% of the CPU, the executable file 118a can be assigned to the configuration file 126a if the capabilities 124a indicate 95% CPU availability for the node 122a. In addition, if the executable file 118b is associated with the software element 114b and the resource requirements 116 indicate that the software element 114b uses five GB of RAM, the executable file 118b can be assigned to the configuration file 126b if the capabilities 124b indicate eight GB of RAM are available for the node 122b. In this way, executable files are matched to configuration files based on the capabilities of the nodes 120. In this example, the CPU of the node 122a is used, while the RAM of the node 122b is used.

Upon assigning the executable files 118a-118b to the configuration files 126a-126b, the management node 110 can execute the configuration files 126a-126b using the nodes 122a-122b. That is, the management node 110 can execute the configuration file 126a, which includes the executable file 118a, using the node 122a. In addition, the management node 110 can execute the configuration file 126b, which includes the executable file 118b, using the node 122b. So, given the capabilities of the nodes 120, executable files for each resource requirement (e.g., memory, disk I/O, CPU, bandwidth, etc.), are assigned to the configuration files for the nodes 120. In this way, rather than distributing a serverless function to run on one node, elements of the serverless function can be distributed to multiple nodes to maximize and balance compute across all nodes.

In some examples, there may be an update to the capabilities 124a-124b for the nodes 120. For instance, the CPU capacity of the node 122b may go from 40% to 100%. Upon determining the update, the management node 110 can reassign the executable file 118a to the configuration file 126b based on the update. The management node 110 can then execute the configuration file 126b that includes the executable file 118a using the node 122b. In this way, the execution of executable files using the nodes 120 is dynamic based on the capabilities 124a-124b according to the resource requirements 116.

Once the executable files 118a-118b are generated for the serverless function 112, the management node 110 can store the executable files 118a-118b in the storage system 130. The executable files 118a-118b can be mapped to the software elements 114a-114b in the storage system 130. The mapping may indicate tasks associated with the software elements 114a-114b. So, if the management node 110 receives another serverless function that includes another set of software elements, the management node 110 can determine whether any of the software elements 114a-114b of the serverless function 112 match the software elements of the other serverless function. If so, rather than generating a new executable file for the matching software element, the management node 110 can retrieve the executable file for the matching software element from the storage system 130. For instance, the other serverless function may have a software element that matches the software element 114a for the serverless function 112. So, the management node 110 can retrieve the executable file 118a for the software element 114a from the storage system 130. The management node 110 can then include the executable file 118a in a set of executable files corresponding to the software elements for the other serverless function. As such, executable files can be reused between serverless functions if they are for software elements that perform the same task.

While FIG. 1 depicts a specific arrangement of components, other examples can include more components, fewer components, different components, or a different arrangement of the components shown in FIG. 1. For instance, while FIG. 1 only shows two nodes, other examples may include a different number of nodes. Also, any component or combination of components depicted in FIG. 1 can be used to implement the process(es) described herein.

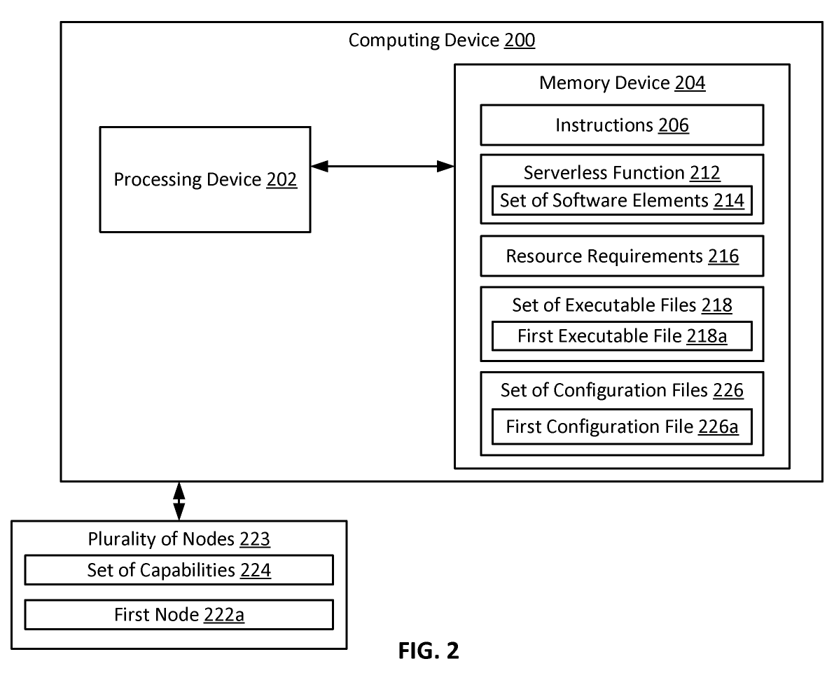

FIG. 2 is a block diagram of an example of a computing device for deploying configuration files generated from serverless functions according to some examples of the present disclosure. The computing device 200 includes a processing device 202 communicatively coupled to a memory device 204. In some examples, the components of the computing device 200, such as the processing device 202 and the memory device 204, may be part of a same computing device, such as the management node 110 in FIG. 1. In other examples, the processing device 202 and the memory device 204 can be included in separate computing devices that are communicatively coupled.

The processing device 202 can include one processing device or multiple processing devices. Non-limiting examples of the processing device 202 can include a Field-Programmable Gate Array (FPGA), an application-specific integrated circuit (ASIC), and a microprocessor. The processing device 202 can execute instructions 206 stored in the memory device 204 to perform computing operations. In some examples, the instructions 206 can include processor-specific instructions generated by a compiler or an interpreter from code written in any suitable computer-programming language, such as C, C++, C#, etc.

The memory device 204 can include one memory or multiple memories. The memory device 204 can be non-volatile and may include any type of memory that retains stored information when powered off. Non-limiting examples of the memory device 204 include electrically erasable and programmable read-only memory (EEPROM), flash memory, or any other type of non-volatile memory. At least some of the memory device 204 can include a non-transitory computer-readable medium from which the processing device 202 can read instructions 206. A computer-readable medium can include electronic, optical, magnetic, or other storage devices capable of providing the processing device 202 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 206.

In some examples, the processing device 202 can execute the instructions 206 to perform some or all of the functionality described herein. For example, the processing device 202 can receive a serverless function 212 including a set of software elements 214. The processing device 202 can determine resource requirements 216 associated with executing the serverless function 212. The processing device 202 can also determine a set of capabilities 224 for a plurality of nodes 223. The processing device 202 can generate a set of executable files 218 corresponding to the set of software elements 214 and the resource requirements 216. The processing device 202 can assign a first executable file 218a of the set of executable files 218 to a first configuration file 226a of a set of configuration files 226 based on the set of capabilities 224. The first configuration file 226a is associated with a first node 222a of the plurality of nodes 223. The processing device 202 can execute the first configuration file 226a having the first executable file 218a using the first node 222a. The first executable file 218a may be associated with a first resource requirement and other executable files of the set of executable files 218 may be associated with other resource requirements and assigned to other configuration files associated with other nodes of the plurality of nodes 223. So, the serverless function 212 is decomposed and distributed in a manner that improves performance of the system and individual nodes.

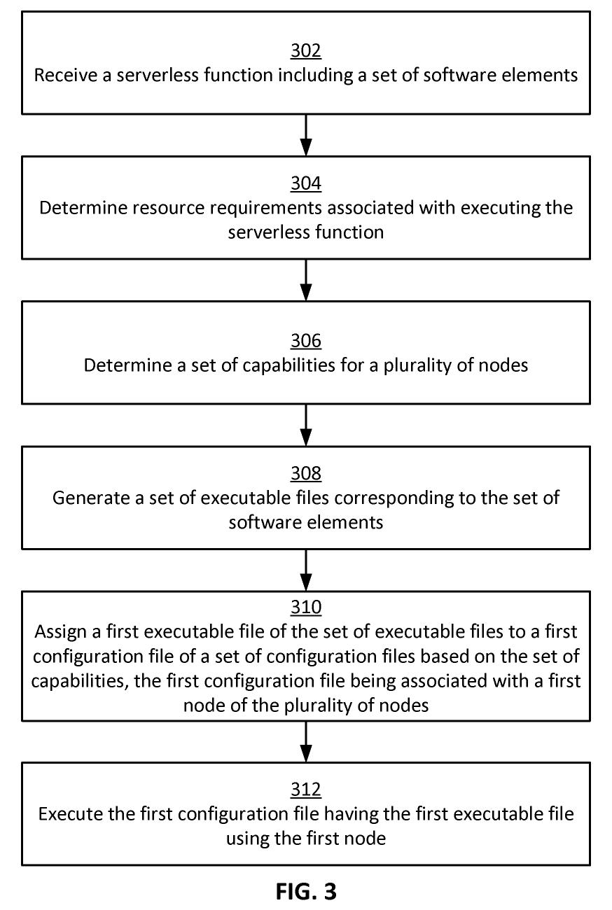

FIG. 3 is a flow chart of an example of a process for deploying configuration files generated from serverless functions according to some examples of the present disclosure. In some examples, the processing device 202 can implement some or all of the steps shown in FIG. 3. Additionally, in some examples, the processing device 202 can be executing on or in communication with the management node 110 of FIG. 1 to implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processing device 202 can receive a serverless function 212 including a set of software elements 214. The set of software elements 214 can be lines of code, where each software element is a portion of the code that is associated with performing a task.

At block 304, the processing device 202 can determine resource requirements 216 associated with executing the serverless function 212. The resource requirements 216 represent hardware and network requirements for executing the serverless function 212. For instance, the resource requirements 216 include RAM requirements, CPU requirements bandwidth requirements, disk I/O requirements, etc.

At block 306, the processing device 202 can determine a set of capabilities 224 for a plurality of nodes 223. The set of capabilities 224 represent the availability of hardware and network resources for each node of the plurality of nodes 223. The set of capabilities 224 may be different than a maximum availability for each node, depending on loads of the plurality of nodes 223.

At block 308, the processing device 202 can generate a set of executable files 218 corresponding to the set of software elements 214 and the resource requirements 216. Each executable file 218 can be associated with a resource requirement of the resource requirements 216. So, a subset of the set of software elements 214 that are CPU intensive can be associated with a first executable file 218a, meaning that the tasks for the subset of the set of software elements 214 are incorporated into the first executable file 218a. Other executable files can be generated for software elements that are memory intensive, disk I/O intensive, network intensive, etc.

At block 310, the processing device 202 can assign the first executable file 218a of the set of executable files 218 to a first configuration file 226a of a set of configuration files 226 based on the set of capabilities 224. The first configuration file 226a is associated with a first node 222a of the plurality of nodes 223. The processing device 202 can determine that the first node 222a has a capacity for executing the first executable file 218a based on the set of capabilities 224. Based on this determination, the processing device 202 assigns the first executable file 218a to the first configuration file 226a, which is associated with the first node 222a. By assigning the first executable file 218a to the first configuration file 226a, the first executable file 218a is incorporated into the first configuration file 226a so that when the first configuration file 226a is executed, the execution includes an execution of the first executable file 218a. Multiple executable files of the set of executable files 218 may be assigned to the same configuration file (e.g., the first configuration file 226a), or, each executable file may be assigned to a different configuration file of the set of configuration files 226 based on the set of capabilities 224.

At block 312, the processing device 202 can execute the first configuration file 226a having the first executable file 218a using the first node 222a. In addition, the processing device 202 can execute other configuration files of the set of configuration files 226 that include other executable files of the set of executable files 218 using the corresponding nodes associated with the configuration files. As such, deployment of the serverless function 212 is distributed across the plurality of nodes 223 based on the set of capabilities 224 so that resources are used more efficiently.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processing device; and
a memory device including instructions that are executable by the processing device for causing the processing device to perform operations comprising:
receiving a serverless function including a set of software elements;
determining resource requirements associated with executing the serverless function;
determining a set of capabilities for a plurality of nodes;
generating a set of executable files corresponding to the set of software elements and the resource requirements;
assigning a first executable file of the set of executable files to a first configuration file of a set of configuration files based on the set of capabilities, the first configuration file being associated with a first node of the plurality of nodes; and
executing the first configuration file having the first executable file using the first node.

2. The system of claim 1, wherein the operations further comprise:
assigning a second executable file of the set of executable files to a second configuration file of the set of configuration files based on the set of capabilities, the second configuration file being associated with a second node of the plurality of nodes, wherein the first executable file is associated with a first resource requirement of the resource requirements, and wherein the second executable file is associated with a second resource requirement of the resource requirements.

3. The system of claim 1, wherein the operations further comprise:
storing the set of executable files including the first executable file for the serverless function in a storage system, wherein each executable file is mapped to a software element of the set of software elements.

4. The system of claim 3, wherein the serverless function is a first serverless function, the set of software elements is a first set of software elements, the set of executable files is a first set of executable files, and wherein the operations further comprise:
receiving a second serverless function including a second set of software elements;
determining a match between a first software element of the first set of software elements and a second software element of the second set of software elements, wherein the first software element and the second software element correspond to the first executable file;
retrieving the first executable file from the storage system; and
including the first executable file in a second set of executable files corresponding to the second set of software elements for the second serverless function.

5. The system of claim 1, wherein determining the resource requirements associated with executing the serverless function comprises:
performing an execution of the serverless function on a device;
analyzing a usage of resources of the device for the execution; and
determining the resource requirements based on the usage of the resources.

6. The system of claim 1, wherein determining the resource requirements associated with executing the serverless function comprises:
executing a benchmark test on the serverless function; and
determining the resource requirements based on the benchmark test.

7. The system of claim 1, wherein the operations further comprise:
determining an update to the set of capabilities for the plurality of nodes; and
reassigning the first executable file to a second configuration file of the set of configuration files based on the update, the second configuration file being associated with a second node of the plurality of nodes.

8. A method comprising:
receiving a serverless function including a set of software elements;
determining resource requirements associated with executing the serverless function;
determining a set of capabilities for a plurality of nodes;
generating a set of executable files corresponding to the set of software elements and the resource requirements;
assigning a first executable file of the set of executable files to a first configuration file of a set of configuration files based on the set of capabilities, the first configuration file being associated with a first node of the plurality of nodes; and
executing the first configuration file having the first executable file using the first node.

9. The method of claim 8, further comprising:
assigning a second executable file of the set of executable files to a second configuration file of the set of configuration files based on the set of capabilities, the second configuration file being associated with a second node of the plurality of nodes, wherein the first executable file is associated with a first resource requirement of the resource requirements, and wherein the second executable file is associated with a second resource requirement of the resource requirements.

10. The method of claim 8, further comprising:
storing the set of executable files including the first executable file for the serverless function in a storage system, wherein each executable file is mapped to a software element of the set of software elements.

11. The method of claim 10, wherein the serverless function is a first serverless function, the set of software elements is a first set of software elements, the set of executable files is a first set of executable files, and the method further comprises:
receiving a second serverless function including a second set of software elements;
determining a match between a first software element of the first set of software elements and a second software element of the second set of software elements, wherein the first software element and the second software element correspond to the first executable file;
retrieving the first executable file from the storage system; and
including the first executable file in a second set of executable files corresponding to the second set of software elements for the second serverless function.

12. The method of claim 8, wherein determining the resource requirements associated with executing the serverless function comprises:
performing an execution of the serverless function on a device;
analyzing a usage of resources of the device for the execution; and
determining the resource requirements based on the usage of the resources.

13. The method of claim 8, wherein determining the resource requirements associated with executing the serverless function comprises:
executing a benchmark test on the serverless function; and
determining the resource requirements based on the benchmark test.

14. The method of claim 8, further comprising:
determining an update to the set of capabilities for the plurality of nodes; and
reassigning the first executable file to a second configuration file of the set of configuration files based on the update, the second configuration file being associated with a second node of the plurality of nodes.

15. A non-transitory computer-readable medium comprising program code that is executable by a processor for causing the processor to perform operations including:
receiving a serverless function including a set of software elements;
determining resource requirements associated with executing the serverless function;
determining a set of capabilities for a plurality of nodes;
generating a set of executable files corresponding to the set of software elements and the resource requirements;
assigning a first executable file of the set of executable files to a first configuration file of a set of configuration files based on the set of capabilities, the first configuration file being associated with a first node of the plurality of nodes; and
executing the first configuration file having the first executable file using the first node.

16. The non-transitory computer-readable medium of claim 15, wherein the operations further comprise:
assigning a second executable file of the set of executable files to a second configuration file of the set of configuration files based on the set of capabilities, the second configuration file being associated with a second node of the plurality of nodes, wherein the first executable file is associated with a first resource requirement of the resource requirements, and wherein the second executable file is associated with a second resource requirement of the resource requirements.

17. The non-transitory computer-readable medium of claim 15, wherein the operations further comprise:
storing the set of executable files including the first executable file for the serverless function in a storage system, wherein each executable file is mapped to a software element of the set of software elements.

18. The non-transitory computer-readable medium of claim 17, wherein the serverless function is a first serverless function, the set of software elements is a first set of software elements, the set of executable files is a first set of executable files, and wherein the operations further comprise:
receiving a second serverless function including a second set of software elements;
determining a match between a first software element of the first set of software elements and a second software element of the second set of software elements, wherein the first software element and the second software element correspond to the first executable file;
retrieving the first executable file from the storage system; and
including the first executable file in a second set of executable files corresponding to the second set of software elements for the second serverless function.

19. The non-transitory computer-readable medium of claim 15, wherein determining the resource requirements associated with executing the serverless function comprises:
performing an execution of the serverless function on a device;
analyzing a usage of resources of the device for the execution; and
determining the resource requirements based on the usage of the resources.

20. The non-transitory computer-readable medium of claim 15, wherein determining the resource requirements associated with executing the serverless function comprises:
executing a benchmark test on the serverless function; and
determining the resource requirements based on the benchmark test.
